(19) United States
(12) Patent Application Publication
(10) Pub. No.: US 2022/0137496 A1
(43) Pub. Date: May 5, 2022

(54) WAVELENGTH CONVERSION DEVICE AND PROJECTION DEVICE

(71) Applicant: Coretronic Corporation, Hsin-Chu (TW)

(72) Inventor: Kuo-Chou Chang, Hsinchu (TW)

(73) Assignee: Coretronic Corporation, Hsin-Chu (TW)

(21) Appl. No.: 17/511,557

(22) Filed: Oct. 27, 2021

(30) Foreign Application Priority Data
Oct. 30, 2020 (CN) 202011190969.1

(51) Int. Cl. G03B 21/20; G02B 13/16; G02B 26/00; G03B 21/14

(52) U.S. Cl. CPC G03B 21/206; G03B 21/142; G02B 26/007; G02B 13/16

(57) ABSTRACT

A wavelength conversion device and a projection device. The wavelength conversion device includes a substrate and a wavelength conversion layer. The wavelength conversion layer is disposed on the substrate and includes a thermal conductive material, a wavelength conversion material, and a hole. A volume percentage of the thermal conductive material in the wavelength conversion layer is 5%-40%, and a volume percentage of the hole in the wavelength conversion layer is 0.5%-10%. When emitted by the laser light source to the wavelength conversion layer, the excitation light beam may be scattered via the hole to thereby increase the proportion of the wavelength conversion material that is excited, which may furthermore increase the light conversion efficiency of the wavelength conversion layer.

### CROSS-REFERENCE TO RELATED APPLICATION

This application claims the priority benefit of China application serial no. 202011190969.1, filed on Oct. 30, 2020. The entirety of the above-mentioned patent application is hereby incorporated by reference herein and made a part of this specification.

### BACKGROUND

### Technical Field

The disclosure relates to an optical device; particularly, the disclosure relates to a wavelength conversion device and a projection device.

### Description of Related Art

Known wavelength conversion layers are formed, for example, by mixing organic adhesives such as silicone with phosphor powders and sintering the same. However, since a thermal conductivity coefficient of the organic adhesive is lower than the thermal conductivity coefficient of the phosphor powder, when an excitation light beam with high power irradiates the wavelength conversion layer, due to the relatively lower thermal conductivity of the organic adhesive, thermal energy will quickly accumulate in the wavelength conversion layer and cause an quenching effect, further decreasing the light conversion efficiency of the wavelength conversion layer.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a wavelength conversion device with high thermal conductivity and high light conversion efficiency, and provides a projection device including the wavelength conversion device.

Other objectives and advantages of the disclosure can be further understood from the technical features disclosed herein.

In order to achieve one, some, or all of the above or other objectives, an embodiment of the disclosure provides a wavelength conversion device, which includes a substrate and a wavelength conversion layer. The wavelength conversion layer is disposed on the substrate and includes a thermal conductive material, a wavelength conversion material, and a hole. A volume percentage of the thermal conductive material in the wavelength conversion layer is 5%-40%, and a volume percentage of the hole in the wavelength conversion layer is 0.5%-10%.

In order to achieve one, some, or all of the above or other objectives, an embodiment of the disclosure provides a projection device, which includes a light source device, a wavelength conversion device, a light valve, and a projection lens. The light source device is configured to provide an excitation light beam. The wavelength conversion device is disposed on a transmission path of the excitation light beam, and includes a substrate and a wavelength conversion layer. The wavelength conversion layer is disposed on the substrate and includes a thermal conductive material, a wavelength conversion material, and a hole. The excitation light beam incident into the wavelength conversion layer is converted into a conversion light beam by the wavelength conversion material. The light valve is disposed on the transmission path of the excitation light beam and the conversion light beam and is configured to convert the excitation light beam and the conversion light beam into an image light beam. The projection lens is disposed on a transmission path of the image light beam and is configured to convert the image light beam into a projection light beam.

Based on the foregoing, the embodiments of the disclosure have at least one of the following advantages or effects. Compared with the conventional art, since the wavelength conversion device of the disclosure includes the thermal conductive material whose material includes aluminum oxide and whose volume percentage in the wavelength conversion layer is 5%-40%, the wavelength conversion device has an increased thermal conductivity. Moreover, since the wavelength conversion device of the embodiments of the disclosure includes the hole with the volume percentage of 0.5%-10% in the wavelength conversion layer, which may furthermore increase the light conversion efficiency of the wavelength conversion layer.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a wavelength conversion device according to an embodiment of the disclosure.

FIG. 2 is a schematic view of a projection device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

Reference will now be made in detail to exemplary embodiments provided in the disclosure, examples of which are illustrated in the accompanying drawings. Wherever possible, the same reference numerals are used in the drawings and descriptions to refer to the same or similar parts. The disclosure may also be embodied in various different forms, and should not be limited to the embodiments described herein. The thickness of layers and regions in the drawings may be exaggerated for the sake of clarity. The same or similar reference numerals refer to the same or similar elements, and will not be repeatedly described in the following paragraphs, respectively. In addition, the directional terms mentioned in the embodiments, such as “above”, “below”, “left”, “right”, “front”, “back’, and the like, refer only to the directions in the accompanying drawings. Therefore, the directional terms are used for explaining instead of limiting the disclosure.

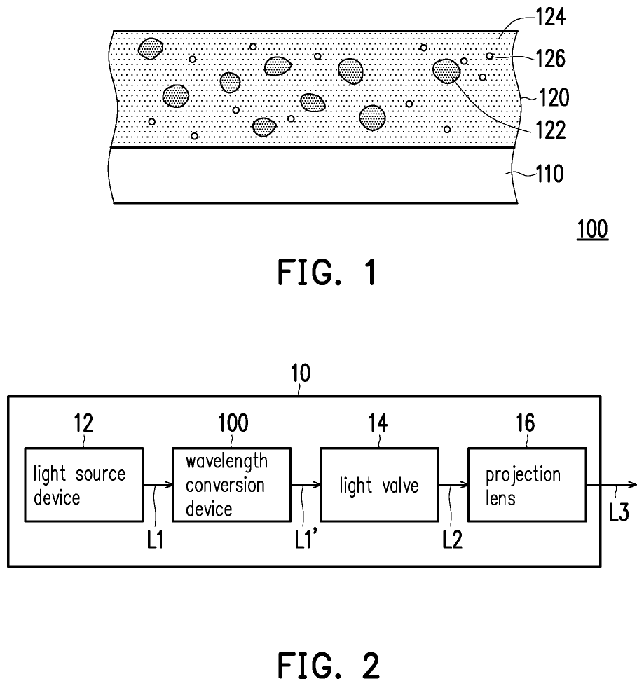

FIG. 1 is a schematic cross-sectional view of a wavelength conversion device according to an embodiment of the disclosure.

With reference to FIG. 1, a wavelength conversion device 100 of this embodiment includes a substrate 110 and a wavelength conversion layer 120.

The material of the substrate 110 may, for example, include aluminum, an aluminum alloy, copper, a copper alloy, aluminum nitride, silicon carbide, or a combination thereof to have relatively high thermal conductivity and heat resistance.

The wavelength conversion layer 120, for example, is disposed on the substrate 110 and configured to convert a wavelength of an excitation light beam emitted by a laser light source (not shown). In some embodiments, the wavelength conversion layer 120 includes a thermal conductive material 122, a wavelength conversion material 124, and a hole 126.

A volume percentage of the thermal conductive material 122 in the wavelength conversion layer 120 is 5%-40%, for example. In a preferred embodiment, the volume percentage of the thermal conductive material 122 in the wavelength conversion layer 120 is 10%-25%. In addition, the thermal conductive material 122 includes aluminum oxide, which has a thermal conductivity coefficient of about 30 W/m·K. In some embodiments, the thermal conductive material 122 includes magnesium aluminum oxide or silicon aluminum oxide.

A volume percentage of the wavelength conversion material 124 in the wavelength conversion layer 120 is 50%-94.5%, for example. In some embodiments, the wavelength conversion material 124 includes an inorganic phosphor material. For example, the wavelength conversion material 124 may include a phosphor powder that emits yellow or green light after being excited by blue light, such as a gadolinium aluminum garnet, a yttrium aluminum garnet, a terbium aluminum garnet, or a lutetium aluminum garnet that is doped with cerium, and has a thermal conductivity coefficient of about 0.8 W/m·K. For example, the wavelength conversion material 124 may include a yttrium aluminum garnet phosphor Y₃Al₅O₁₂:Ce that emits yellow light after being excited or a lutetium aluminum garnet phosphor Lu₃Al₅O₁₂:Ce that emits green light after being excited. The disclosure is not particularly limited thereto. The wavelength conversion material 124 whose material includes a garnet structure and the thermal conductive material 122 whose material includes aluminum oxide may form a eutectic phase to form a homogeneous mixture.

Since the wavelength conversion device 100 of this embodiment includes the thermal conductive material 122 whose material includes aluminum oxide and whose volume percentage in the wavelength conversion layer 120 is 5%-40%, which has a relatively high thermal conductivity, the wavelength conversion layer 120 obtained from mixing the thermal conductive material 122 and the wavelength conversion material 124 and sintering the same has an increased thermal conductivity. However, where the volume percentage of the thermal conductive material 122 in the wavelength conversion layer 120 exceeds 40%, the proportion of the wavelength conversion material 124 in the wavelength conversion layer 120 will be reduced, and accordingly the light conversion efficiency of the wavelength conversion layer 120 will be reduced. Therefore, the volume percentage of the thermal conductive material 122 in the wavelength conversion layer 120 is preferably 5%-40%.

A volume percentage of the hole 126 in the wavelength conversion layer 120 is 0.5%-10%, for example. The hole 126 may, for example, be formed when a solvent in the wavelength conversion layer 120 evaporates during a manufacturing process of the wavelength conversion layer 120. The disclosure is not particularly limited thereto. In some embodiments, a diameter of the hole is 0.5 μm-5 μm.

Since the wavelength conversion device 100 of this embodiment includes the hole 126 with the volume percentage of 0.5%-10% in the wavelength conversion layer 120, when emitted by the laser light source to the wavelength conversion layer 120, the excitation light beam may be scattered via the hole 126 to thereby increase the proportion of the wavelength conversion material 124 that is excited, which may furthermore increase the light conversion efficiency of the wavelength conversion layer 120. However, where the volume percentage of the hole 126 in the wavelength conversion layer 120 exceeds 10%, a scattering angle of the excitation light beam will thus be overly large, reducing the proportion of the wavelength conversion material 124 that is excited and affecting the light conversion efficiency of the wavelength conversion layer 120. Therefore, the volume percentage of the hole 126 in the wavelength conversion layer 120 is preferably 0.5%-10%. Moreover, the hole 126 included in the wavelength conversion device 100 of this embodiment may suppress an extension of the wavelength conversion layer 120 when the wavelength conversion layer 120 is influenced by the external environment and micro cracks are generated, and may also serve as a buffer, so that the wavelength conversion layer 120 has excellent toughness.

In some embodiments, the wavelength conversion layer 120 may further include a bonding material (not shown), by which, for example, the wavelength conversion material 124 may be gathered and adhered to the substrate 110. The bonding material may, for example, include an inorganic material. In some embodiments, the bonding material may include glass, ceramic, or a combination thereof.

Based on the foregoing, since the wavelength conversion device of this embodiment includes the thermal conductive material whose material includes aluminum oxide and whose volume percentage in the wavelength conversion layer is 5%-40%, the wavelength conversion device of this embodiment has an increased thermal conductivity. Moreover, since the wavelength conversion device of this embodiment includes the hole with the volume percentage of 0.5%-10% in the wavelength conversion layer, when emitted by the laser light source to the wavelength conversion layer, the excitation light beam may be scattered via the hole to thereby increase the proportion of the wavelength conversion material that is excited, which may furthermore increase the light conversion efficiency of the wavelength conversion layer.

FIG. 2 is a schematic view of a projection device according to an embodiment of the disclosure.

With reference to FIG. 2, a projection device 10 of this embodiment includes a light source device 12, the wavelength conversion device 100, a light valve 14, and a projection lens 16.

The light source device 12 is configured to provide an excitation light beam L1, for example. In this embodiment, the light source device 12 includes a laser light source, and the excitation light beam L1 emitted thereby includes a blue light beam. For example, the light source device 12 may include a laser diode array (not shown) emitting blue light, but the disclosure is not limited thereto.

The wavelength conversion device 100 is a phosphor wheel, for example. The wavelength conversion device 100 is disposed on a transmission path of the excitation light beam L1, for example. In addition, the wavelength conversion device 100 is configured to sequentially convert the excitation light beam L1 into a conversion light beam and allow the excitation light beam L1 to pass through. For example, through a driving element (not shown) included in the wavelength conversion device 100, a light passing area (not shown) and the wavelength conversion layer 120 enter an irradiation range of the excitation light beam L1 in different time periods. For the relative positions and functions of the components included in the wavelength conversion device 100, reference may be made to the above embodiments, and will not be repeated herein.

In some embodiments, the projection device 10 may further include a light splitting unit (not shown) disposed between the light source device 12 and the wavelength conversion device 100. In other words, the light splitting unit is disposed on the transmission path of the excitation light beam L1, for example. The beam splitting unit includes an element that separates the light beam. For example, the light splitting unit may allow a blue light beam to pass through, while providing reflection of light beams of other colors. In this embodiment, the light splitting unit may allow the excitation light beam L1 that is blue to pass through. In this way, the excitation light beam L1 may pass through the light splitting unit and be incident into the wavelength conversion device 100. Herein, an illumination light beam L1′ departing from the wavelength conversion device 100 includes the excitation light beam L1 and the conversion light beam that are sequentially generated.

The light valve 14 is, for example, disposed on a transmission path of the illumination light beam L1′ and configured to transform the illumination light beam L1′ into an image light beam L2. In some embodiments, the light valve 14 is, for example, a reflective light modulator such as a liquid crystal on silicon panel (LCoS panel) or a digital micro-mirror device (DMD). In some other embodiments, the light valve 14 is, for example, a transparent light modulator such as a transparent liquid crystal panel, an electro-optical modulator, a magneto-optic modulator, or an acousto-optic modulator (AOM). The disclosure is not limited thereto.

The projection lens 16 is, for example, disposed on a transmission path of the image light beam L2 and configured to project the image light beam L2 out of the projection device 10. In some embodiments, the projection lens 16 includes, for example, one or a combination of multiple optical lenses having refractive power, such as various combinations of non-planar lenses including biconcave lenses, biconvex lenses, concave-convex lenses, convex-concave lenses, plano-convex lenses, and plano-concave lenses. In some other embodiments, the projection lens 16 may also include a planar optical lens. The disclosure is not limited thereto. Based on the above, the projection lens 16 may, in a reflective or transparent manner, convert the image light beam L2 from the light valve 14 into a projection light beam L3 and project the same out of the projection device 10.

In summary of the foregoing, the embodiments of the disclosure have at least one of the following advantages or effects. Compared with the conventional art, since the wavelength conversion device of the disclosure includes the thermal conductive material whose material includes aluminum oxide and whose volume percentage in the wavelength conversion layer is 5%-40%, the wavelength conversion device of the embodiments of the disclosure has an increased thermal conductivity. Moreover, since the wavelength conversion device of the embodiments of the disclosure includes the hole with the volume percentage of 0.5%-10% in the wavelength conversion layer, when emitted by the laser light source to the wavelength conversion layer, the excitation light beam may be scattered via the hole to thereby increase the proportion of the wavelength conversion material that is excited, which may furthermore increase the light conversion efficiency of the wavelength conversion layer.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A wavelength conversion device, comprising a substrate and a wavelength conversion layer, wherein
the wavelength conversion layer is disposed on the substrate, and the wavelength conversion layer comprises a thermal conductive material, a wavelength conversion material, and a hole,
wherein a volume percentage of the thermal conductive material in the wavelength conversion layer is 5%-40%; and
wherein a volume percentage of the hole in the wavelength conversion layer is 0.5%-10%.

2. The wavelength conversion device according to claim 1, wherein the volume percentage of the thermal conductive material in the wavelength conversion layer is 10%-25%.

3. The wavelength conversion device according to claim 1, wherein the thermal conductive material comprises aluminum oxide.

4. The wavelength conversion device according to claim 3, wherein the thermal conductive material comprises magnesium aluminum oxide or silicon aluminum oxide.

5. The wavelength conversion device according to claim 1, wherein a volume percentage of the wavelength conversion material in the wavelength conversion layer is 50%-94.5%.

6. The wavelength conversion device according to claim 1, wherein the wavelength conversion material comprises a gadolinium aluminum garnet, a yttrium aluminum garnet, a terbium aluminum garnet, or a lutetium aluminum garnet that is doped with cerium.

7. The wavelength conversion device according to claim 1, wherein a diameter of the hole is 0.5 μm-5 μm.

8. A projection device, comprising a light source device, a wavelength conversion device, a light valve, and a projection lens, wherein
the light source device is configured to provide an excitation light beam;
the wavelength conversion device is disposed on a transmission path of the excitation light beam, wherein the wavelength conversion device comprises a substrate and a wavelength conversion layer, wherein
the wavelength conversion layer is disposed on the substrate, the wavelength conversion layer comprises a thermal conductive material, a wavelength conversion material, and a hole, and the excitation light beam incident into the wavelength conversion layer is converted into a conversion light beam by the wavelength conversion material,
wherein a volume percentage of the thermal conductive material in the wavelength conversion layer is 5%-40%; and
wherein a volume percentage of the hole in the wavelength conversion layer is 0.5%-10%;
the light valve is disposed on the transmission path of the excitation light beam and the conversion light beam and configured to convert the excitation light beam and the conversion light beam into an image light beam; and
the projection lens is disposed on a transmission path of the image light beam and configured to convert the image light beam into a projection light beam.
